(19) United States
(12) Patent Application Publication
(10) Pub. No.: US 2026/0142403 A1
(43) Pub. Date: May 21, 2026

(54) CONNECTOR ASSEMBLY

(71) Applicant: SUMITOMO WIRING SYSTEMS, LTD., Mie (JP)

(72) Inventor: Hiroki YOSHIHARA, Mie (JP)

(21) Appl. No.: 19/391,212

(22) Filed: Nov. 17, 2025

(30) Foreign Application Priority Data
Nov. 20, 2024 (JP) 2024-202379

(51) Int. Cl. H01R 13/502; H01R 13/405

(52) U.S. Cl. CPC H01R 13/502; H01R 13/405

(57) ABSTRACT

A connector assembly includes: a sub-connector including a housing and a terminal held in the housing; and a frame including an accommodating portion into which the sub-connector is capable of being inserted. The housing includes a housing body capable of accommodating the terminal and a retainer piece integrally molded with the housing body, and the retainer piece is formed so as to be capable of bending from an open state in which the retainer piece extends diagonally relative to an insertion direction of the sub-connector to a closed state in which the retainer piece extends in the insertion direction. In the open state, the retainer piece allows the terminal to be inserted into the housing body, and in the closed state, the retainer piece locks the terminal that has been accommodated in the housing body.

### CROSS-REFERENCE TO RELATED APPLICATIONS

This application is based on and claims priority from Japanese Patent Application No. 2024-202379, filed on November 20, 2024, with the Japan Patent Office, the disclosure of which is incorporated herein in its entirety by reference.

### TECHNICAL FIELD

The present disclosure relates to a connector assembly.

### BACKGROUND

A conventional connector assembly includes sub-connectors and a frame including accommodating portions into which the sub-connectors can be inserted (see, for example, Japanese Patent Laid-open Publication No. 2009-252513). Each sub-connector includes a housing and terminals held inside the housing. The housing includes a housing body capable of accommodating the terminals and a retainer piece that is integrally molded with the housing body. The retainer piece is formed so as to be capable of bending with a base end as a pivot from an open state, where the retainer piece extends diagonally to the insertion direction of the sub-connector, to a closed state, where the retainer piece extends in the insertion direction. In the open state, the retainer piece allows terminals to be inserted into the housing body, and in the closed state, the retainer piece locks the terminals accommodated in the housing body. The frame includes an engagement recess, which is located on an end surface in a direction where the accommodating portions are open and engages the retainer piece in the open state to prevent the insertion of sub-connectors into the accommodating portions. In this type of connector assembly, the sub-connectors are prevented from being inserted into the accommodating portions in the open state where the retainer piece does not lock the terminals. With this configuration, improper attachment of the sub-connectors and the frame is prevented.

### SUMMARY

However, with a connector assembly like that described above, if a strong insertion force is applied to a sub-connector in a state where the retainer piece engages the engagement recess, there is a risk that the retainer piece will buckle and bulge outward, resulting in the retainer piece breaking. Accordingly, there is a risk that a sub-connector may be attached to the frame without the terminals being properly locked, for example.

It is an object of the present disclosure to provide a connector assembly that can ensure stable and proper assembly.

A connector assembly according to an aspect of the present disclosure includes: a connector including a housing and a terminal held in the housing; and a mating component including an accommodating portion into which the connector is capable of being inserted along an insertion axis, wherein the housing includes a housing body capable of accommodating the terminal and a retainer piece that is integrally molded with the housing body, the retainer piece is formed so as to be capable of bending about a base end thereof as a pivot from an open state in which the retainer piece extends diagonally relative to an insertion direction of the connector to a closed state in which the retainer piece extends in the insertion direction, in the open state, the retainer piece allows the terminal to be inserted into the housing body, and in the closed state, the retainer piece locks the terminal that has been accommodated in the housing body, and the accommodating portion includes a stopper surface, which is located at a position further inward in the insertion direction than an open end of the accommodating portion and engages with the retainer piece in the open state to prevent the connector from being inserted into the accommodating portion.

With the connector assembly according to an aspect of the present disclosure, stable and proper assembly is ensured.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector assembly according to an embodiment of the present disclosure.

FIG. 2 is an exploded perspective view of the connector assembly according to the present embodiment.

FIG. 3 is a plan view of a frame according to the present embodiment.

FIG. 4 is an enlarged perspective view of part of an accommodating portion according to the present embodiment.

FIG. 5 is a cross-sectional view taken along a line 5-5 in FIG. 3.

FIG. 6 is a sectional perspective view of part of a housing and a terminal according to the present embodiment.

FIG. 7 is a cross-sectional view of a sub-connector according to the present embodiment.

FIG. 8 is a cross-sectional view of an initial stage of assembly of a connector assembly according to the present embodiment.

FIG. 9 is a cross-sectional view of an intermediate stage of assembly of a connector assembly according to the present embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### [Outline of Embodiments of the Present Disclosure]

Several embodiments of the present disclosure will first be listed and described in outline.

(1) A connector assembly according to an aspect of the present disclosure includes: a connector including a housing and a terminal held in the housing; and a mating component including an accommodating portion into which the connector is capable of being inserted along an insertion axis, wherein the housing includes a housing body capable of accommodating the terminal and a retainer piece that is integrally molded with the housing body, the retainer piece is formed so as to be capable of bending about a base end thereof as a pivot from an open state in which the retainer piece extends diagonally relative to an insertion direction of the connector to a closed state in which the retainer piece extends in the insertion direction, in the open state, the retainer piece allows the terminal to be inserted into the housing body, and in the closed state, the retainer piece locks the terminal that has been accommodated in the housing body, and the accommodating portion includes a stopper surface, which is located at a position further inward in the insertion direction than an open end of the accommodating portion and engages with the retainer piece in the open state to prevent the connector from being inserted into the accommodating portion.

According to this configuration, since the accommodating portion includes a stopper surface that engages a retainer piece in the open state to prevent the connector from being inserted into the accommodating portion, insertion of a connector into an accommodating portion in a state where the retainer piece is not locking the terminal is prevented. Accordingly, improper assembly of the connector and the mating component is prevented. Also, since the stopper surface is provided further inward in the insertion direction than the open end of the accommodating portion, even if a strong insertion force is applied to a connector in a state where the retainer piece has engaged the stopper surface, buckling so as to bulge outward of the retainer piece can be prevented. In other words, because the stopper surface is provided further inward in the insertion direction than the open end of the accommodating portion, when a retainer piece has engaged the stopper surface, an inner wall surface of the accommodating portion will face the outside of the retainer piece. This means that even if a retainer piece is about to buckle so as to bulge outward, the retainer piece will contact the inner wall surface of the accommodating portion, thereby preventing buckling. This can prevent breakage of the retainer piece and ensure stable and proper assembly.

(2) In the connector assembly according to (1) above, the connector may include a plurality of the terminals, and the retainer piece may be formed so that a single retainer piece is capable of locking the plurality of terminals.

With this configuration, because a single retainer piece is formed so as to be capable of locking a plurality of terminals, compared to a configuration in which each retainer piece can lock only one terminal, stress that occurs when force is applied can be dispersed, making the retainer piece less susceptible to breaking. Accordingly, more stable and proper assembly can be ensured.

(3) In the connector assembly according to (2) above, the housing may be formed as a rectangular cuboid, and the retainer piece may be formed so that a single retainer piece is capable of locking all of the plurality of terminals aligned along a length direction of the housing.

According to this configuration, because the retainer piece is formed so that a single retainer piece can lock all of the terminals aligned along the length axis of the housing, compared for example to a configuration in which one retainer piece can engage only some of the terminals aligned along the length axis, stress that occurs when force is applied can be more favorably dispersed, making the retainer piece less susceptible to breaking. Accordingly, more stable and proper assembly can be ensured.

(4) In the connector assembly according to any one of (1) to (3) above, the retainer piece may include a projection at a front end in the insertion direction, and the stopper surface may be inclined to guide the retainer piece in a direction where the retainer piece opens further when an insertion force is applied to the connector in a state where the projection contacts the stopper surface.

With this configuration, the retainer piece has a projection at a front end in the insertion direction, and because the stopper surface is inclined to guide the retainer piece in a direction that opens further when an insertion force is applied to the connector in a state where the projection contacts the stopper surface, proper bracing by the retainer piece is facilitated. Accordingly, a state where an intermediate portion of a retainer piece starts to bulge outwards, or in other words, starts to buckle is less likely to occur. It is also less likely for example for a state where a retainer piece is forcibly inserted in the insertion direction beyond a stopper surface to occur.

(5) In the connector assembly according to any one of (1) to (4) above, a length from an open end of the accommodating portion to the stopper surface may be longer than a length along the insertion axis of the retainer piece.

With this configuration, because the length from the open end of the accommodating portion to the stopper surface is greater than the length of the retainer piece along the insertion axis, outward bulging of the retainer piece is suppressed, even near the base end of the retainer piece. Accordingly, buckling of the retainer piece is further prevented.

### [Detailed Embodiments of the Present Disclosure]

Specific examples of a connector assembly according to the present disclosure will be described below with reference to the accompanying drawings. In the drawings, for ease of explanation, parts of the configuration may be exaggerated or simplified. The relative dimensions of parts may also differ between drawings.

The expression "tubular" used in the present specification refers not only to a tubular object which has a continuous peripheral wall formed around the entire circumference, but also includes a tubular object formed by combining a plurality of parts, or a tubular object including a partial cutaway or the like in the circumferential direction, like a C shape. The external circumferential form of a "tubular" shape includes, but is not limited to a circle, an ellipse, and polygons with pointed or rounded corners. "Tubular" as used here refers to a shape with a through hole in plan view, and includes shapes where the outer circumferential shape and the inner circumferential shape of the through hole are the same, and shapes where the outer circumferential shape and the inner circumferential shape of the through hole differ. The expression "tubular" includes shapes that have a predetermined length extending along an axial direction of a central axis that passes through the center of the through hole, but such predetermined length may have any magnitude. In the present specification, the expression "facing" refers to the respective front-surface positions of different surfaces or members, and includes not only a case where the positions of front surfaces completely coincide but also cases where the positions of front surfaces partially coincide. In addition, the expressions "first", "second", "third", and the like in the present specification are used simply to distinguish between objects and do not indicate rankings of the objects. Note that the present invention is not limited to the embodiments described here, is indicated by the scope of the patent claims, and is intended to include all modifications within the meaning and scope of the claims.

### (Configuration of Connector Assembly 10)

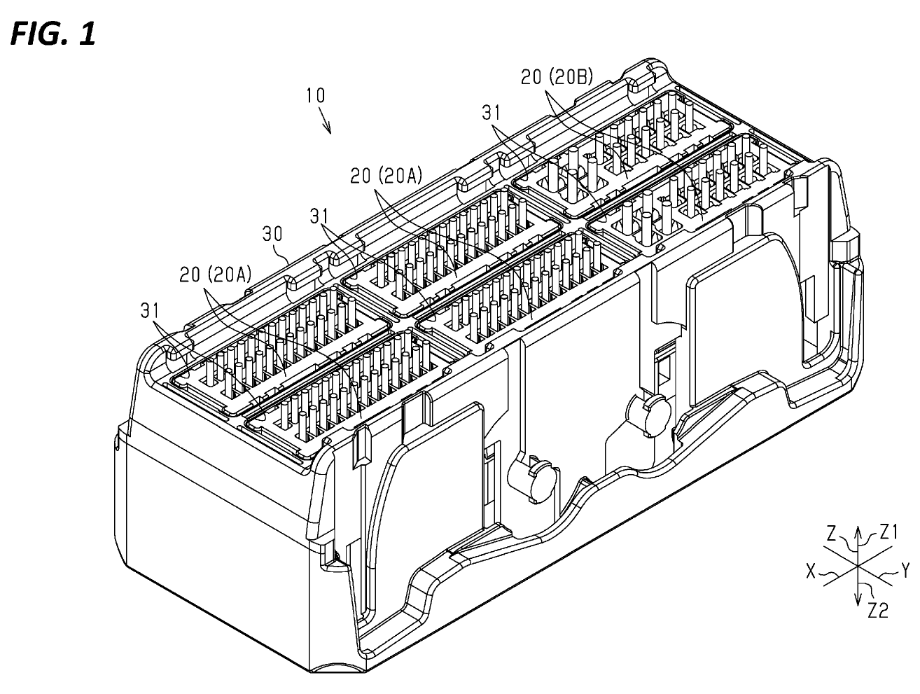

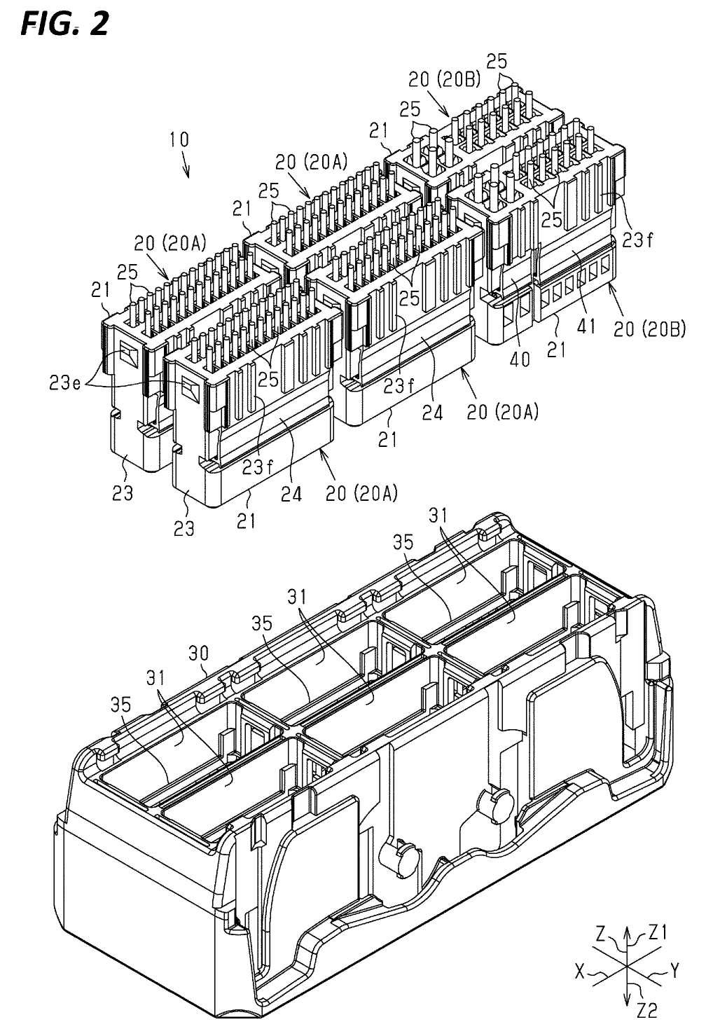

As shown in FIGS. 1 and 2, a connector assembly 10 includes a plurality of sub-connectors 20 as connectors and a frame 30 as a mating component. In the present embodiment, the connector assembly 10 includes six sub-connectors 20. The six sub-connectors 20 in the present embodiment include four sub-connectors 20A and two sub-connectors 20B of a different type from the sub-connectors 20A. The sub-connectors 20A will be described later in the present embodiment. As one example, the connector assembly 10 is installed on a path that electrically connects vehicle-mounted devices installed in a vehicle and is fitted together with a mating connector (not shown). Note that a first axis X, a second axis Y that is perpendicular to the first axis X, and a third axis Z as an insertion axis which is perpendicular to the first axis X and the second axis Y are indicated in the drawings. An upward direction Z1, which is one direction along the third axis Z, and a downward direction Z2, which is the insertion direction and is opposite the upward direction Z1, are also indicated in the drawings.

### (Configuration of Sub-Connector 20A)

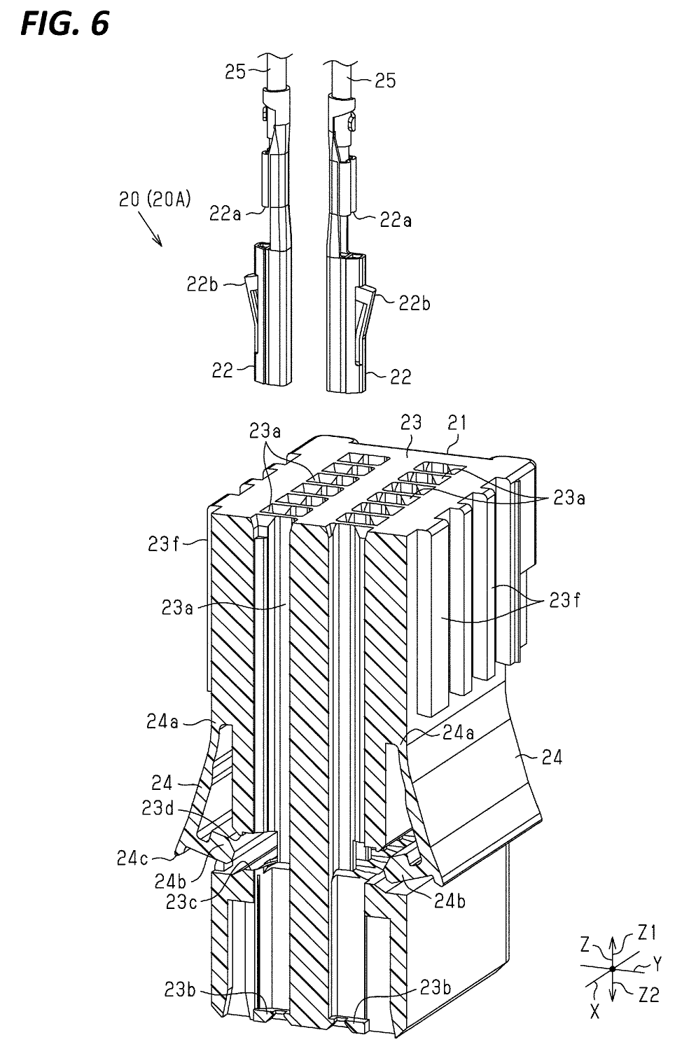

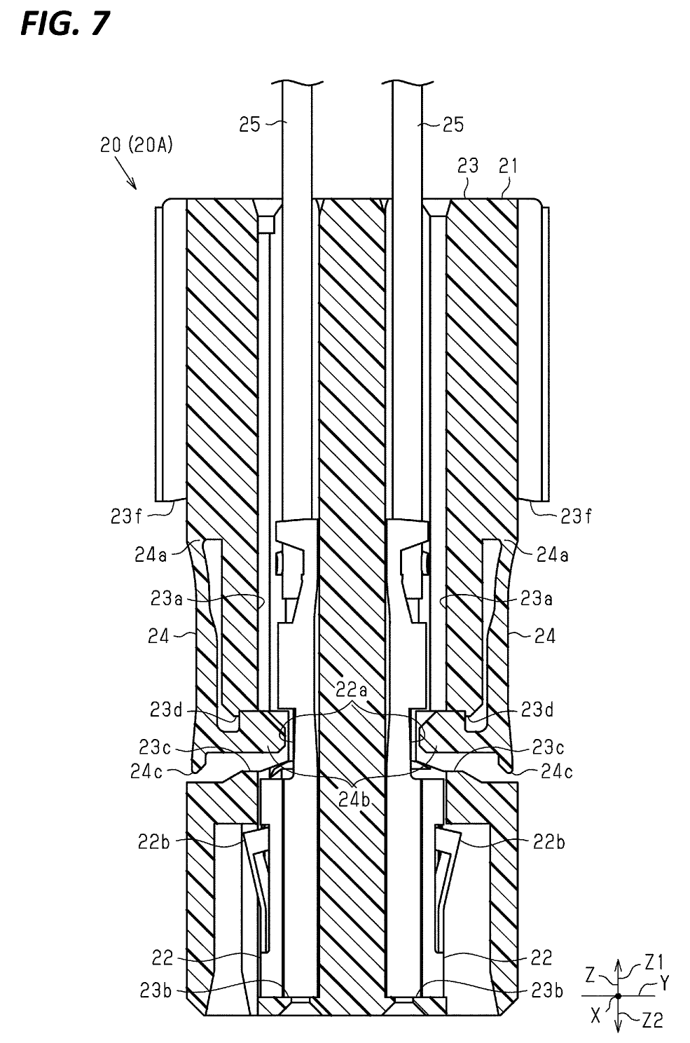

As shown in FIGS. 6 and 7, each sub-connector 20A includes a housing 21 and a plurality of terminals 22 held in the housing 21. Note that in FIG. 6, only some out of the plurality of terminals 22 are shown. The housing 21 is formed as a rectangular cuboid.

The housing 21 includes a housing body 23 capable of accommodating the terminals 22 and retainer pieces 24 that are integrally molded on the housing body 23.

The housing body 23 includes a plurality of terminal accommodating holes 23a that pass through the housing body 23 along the third axis Z. In the present embodiment, 13 terminal accommodating holes 23a are aligned side by side along the first axis X, which is the length axis of the housing 21 (see FIGS. 1 and 2), and two terminal accommodating holes 23a are aligned side by side along the second axis Y, making a total of 26 terminal accommodating holes 23a. The terminal accommodating holes 23a are smaller in size at their lower ends 23b. At an intermediate location along the third axis Z, each terminal accommodating hole 23a includes an intermediate opening 23c, which is open to the outside along the second axis Y. A locking protrusion 23d, which protrudes in the downward direction Z2 is provided on an upward direction z1-side inner surface of the intermediate opening 23c.

The plurality of terminals 22 extend along the third axis Z and are accommodated and held inside the terminal accommodating holes 23a in a state where the terminals 22 are connected to wires 25 that extend in the upward direction Z1. Note that as one example in the present embodiment, the terminals 22 are female terminals that are capable of mating with rod-shaped male terminals, not illustrated, provided on the mating connector. Each terminal 22 includes a terminal recess 22a at an intermediate position along the third axis Z. Each terminal 22 also includes a lance portion 22b between the terminal recess 22a and a lower end of the terminal 22. As shown in FIG. 7, when the terminals 22 are inserted into the terminal accommodating holes 23a until the terminals 22 abut the lower ends 23b of the terminal accommodating holes 23a, the terminal recesses 22a become disposed so as to match the intermediate openings 23c and the lance portions 22b prevent the terminals 22 from coming out of the terminal accommodating holes 23a.

The retainer pieces 24 are provided on both sides along the second axis Y of the housing body 23. The retainer pieces 24 extend in the downward direction z2 from a base end 24a, which is located above the intermediate openings 23c in the upward direction z1 on the housing body 23. Each retainer piece 24 includes a locking claw 24b that protrudes from a front end in the downward direction Z2 of the retainer piece 24 in a direction that fits into the intermediate opening 23c, that is, inward along the second axis Y. Each retainer piece 24 also has a projection 24c at its front end in the downward direction Z2 that protrudes further in the downward direction Z2 than the locking claw 24b.

Each retainer piece 24 is formed to be capable of bending with the base end 24a as a pivot from an open state (see FIG. 6), in which the retainer piece 24 extends diagonally outward in the downward direction Z2, to a closed state (see FIG. 7) in which the retainer piece 24 extends downward in the Z2 direction. Note that in the present embodiment, each retainer piece 24 is formed to be in the open state when no force is applied.

As shown in FIG. 6, in the open state, each retainer piece 24 allows the terminals 22 to be inserted into the terminal accommodating holes 23a of the housing body 23. In more detail, in the open state, the locking claws 24b of the retainer pieces 24 are positioned outside the intermediate openings 23c, which allows the terminals 22 to be inserted into the terminal accommodating holes 23a.

As shown in FIG. 7, in the closed state, the retainer pieces 24 lock the terminals 22 accommodated in the terminal accommodating holes 23a of the housing body 23. In more detail, in the closed state, the locking claws 24b of the retainer pieces 24 pass through the intermediate openings 23c and fit into the terminal recesses 22a, thereby preventing terminals 22 that have been inserted to the proper positions in the terminal accommodating holes 23a from coming out. In the closed state, the retainer pieces 24 maintain the closed state due to engagement of the locking claws 24b with the locking protrusions 23d of the intermediate openings 23c.

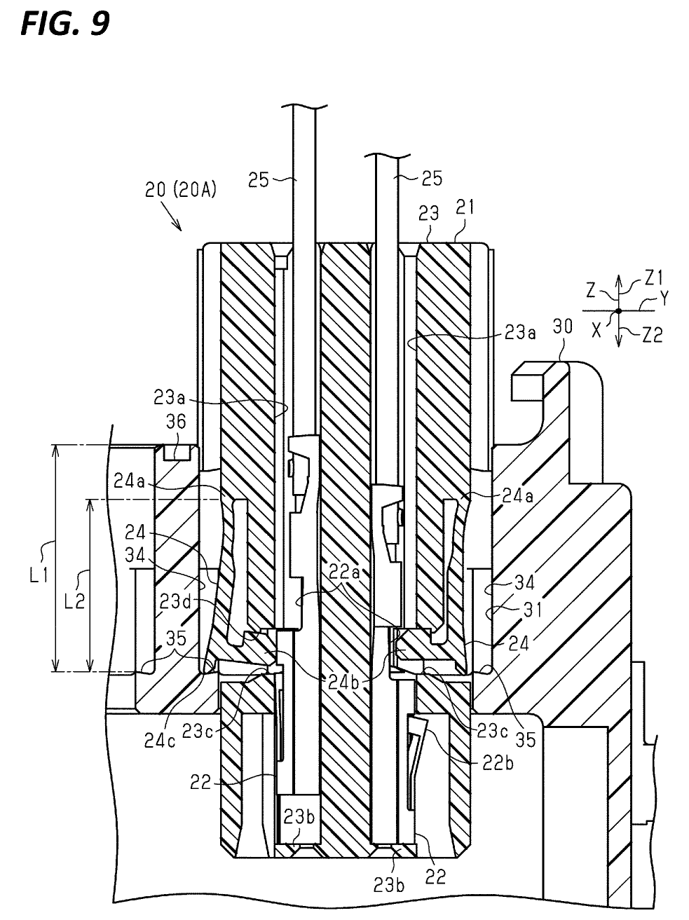

As shown in FIG. 9, if a terminal 22 (refer to the terminal 22 on the left in FIG. 9) has not been inserted as far as the proper position, the retainer piece 24 will not enter the closed state due to the locking claw 24b contacting the terminal 22 itself and not fitting into the terminal recess 22a. Note that in this situation, a retainer piece 24 of the present embodiment will be half open in the open state due to the locking claw 24b pressing against the locking protrusion 23d of an intermediate opening 23c and remaining at a position where the retainer piece 24 contacts the terminal 22.

As shown in FIG. 6, each retainer piece 24 is formed so as to be capable of locking a plurality of terminals 22. In more detail, each retainer piece 24 is formed so as to extend along the first axis X so that a single retainer piece 24 is capable of locking a plurality of terminals 22 housed in a plurality of terminal accommodating holes 23a aligned along the first axis X. In the present embodiment, the retainer pieces 24 are formed along the entire first axis X, which is the length axis of the housing 21 (see FIG. 2), and are configured so that a single retainer piece 24 can lock all of the terminals 22 aligned along the first axis X. Note that FIG. 6 does not show the plurality of terminals 22 aligned along the first axis X, and only shows representative terminals 22.

As shown in FIG. 2, each housing body 23 has locking projections 23e. The locking projections 23e protrude in a direction that intersects the third axis Z. The locking projections 23e are provided at positions on the housing body 23 toward the upward direction Z1 end along the third axis Z. The locking projections 23e are provided on both sides of the housing body 23 along the first axis X, which is the length axis. Note that in FIG. 2, only one of the locking projections 23e on both sides on the first axis X is shown.

As shown in FIG. 6, each housing body 23 also includes stop ribs 23f. The stop ribs 23f are provided at upward direction Z1-side positions along the third axis Z on the housing body 23. The stop ribs 23f are provided to protrude outward from both sides of the housing body 23 on the second axis Y, which is the short axis of the housing body 23. The stop ribs 23f extend along the third axis Z and are provided in a plurality of rows along the first axis X.

### (Configuration of Frame 30)

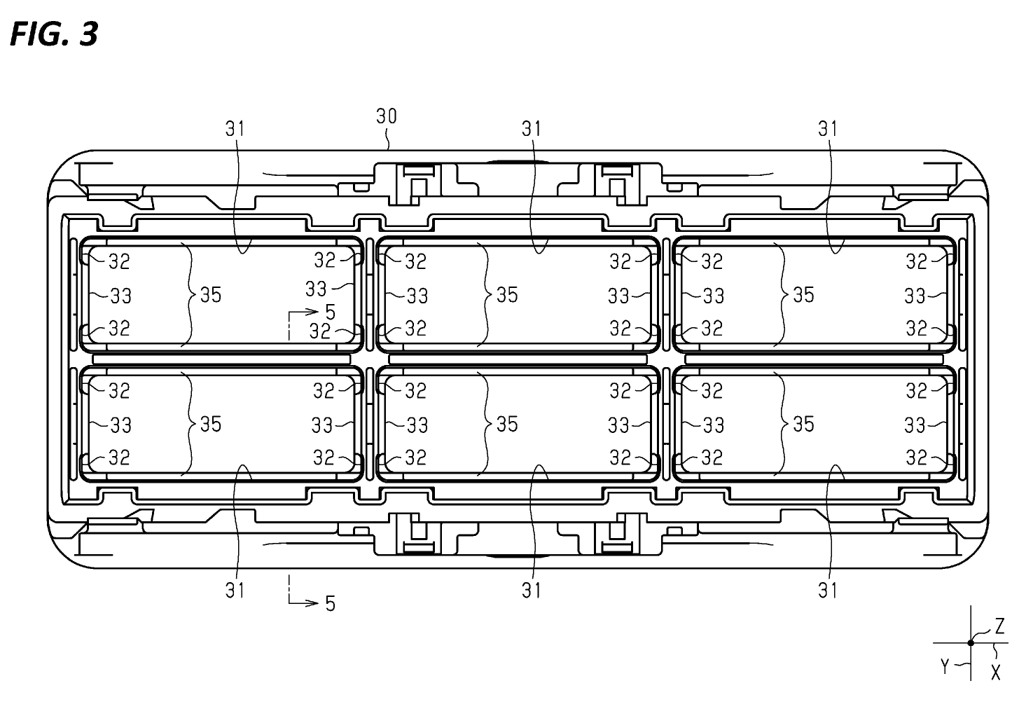

As shown in FIGS. 2 and 3, the frame 30 includes a plurality of accommodating portions 31. The frame 30 according to the present embodiment includes six accommodating portions 31. Three accommodating portions 31 are aligned along the first axis X and two accommodating portions 31 are aligned along the second axis Y, making a total of six accommodating portions 31. The accommodating portions 31 are configured to allow the sub-connectors 20A, 20B (see FIG. 2) to be inserted along the third axis Z. That is, each accommodating portion 31 is formed in the shape of a rectangular tube that extends along the third axis Z.

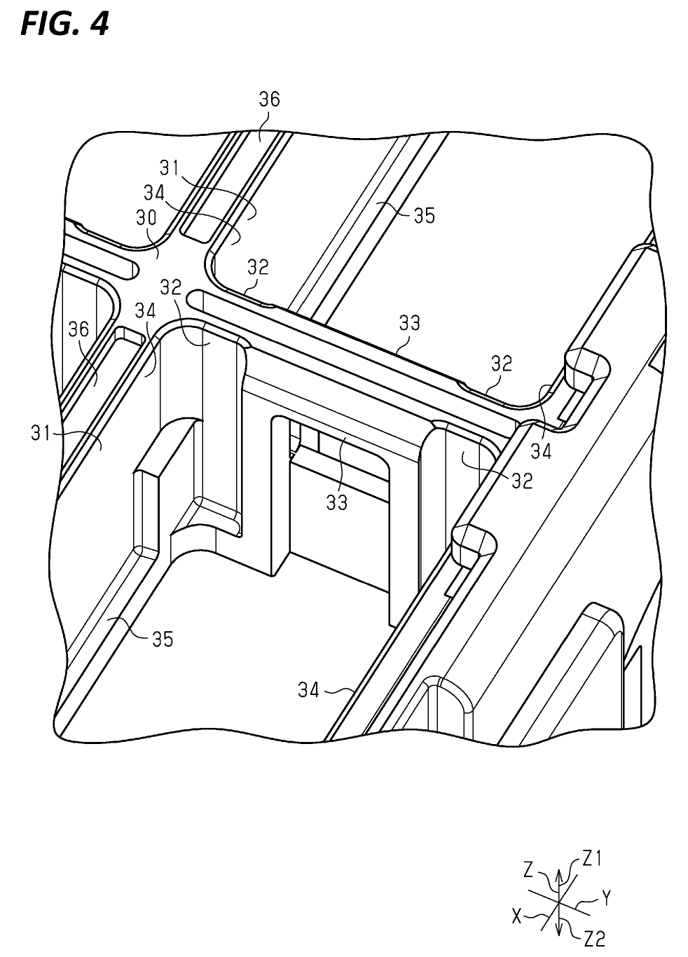

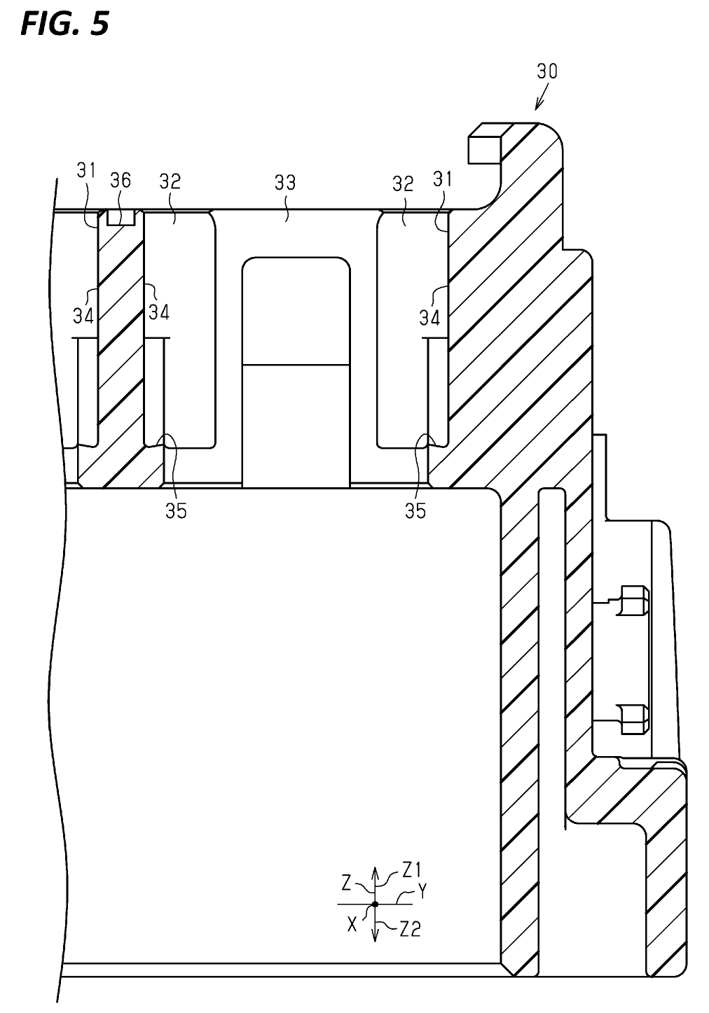

As shown in FIGS. 3 to 5, each accommodating portion includes elastic portions 32 and locking claws 33. The elastic portions 32 and the locking claws 33 are provided on both sides along the first axis X of each accommodating portion 31. Each locking claw 33 is provided at the upward direction Z1 end of an accommodating portion 31 (see FIG. 4).

In more detail, the elastic portions 32 are provided on both sides of each locking claw 33. The pair of elastic portions 32 extend from both sides of the locking claw 33 in directions away from each other along the second axis Y, and are connected to a pair of facing surfaces 34 that form an inner wall surface of an accommodating portion 31. The elastic portions 32 are elastic due to their thickness along the first axis X being thinner than the thickness of the locking claw 33. This enables the locking claw 33 to become displaced along the first axis X due to bending of the elastic portions 32.

While a sub-connector 20A is being inserted into an accommodating portion 31, the locking claws 33 become displaced due to the elastic portions 32 flexing, which enables the locking projections 23e (see FIG. 2) to pass. In the state where the sub-connector 20A has been inserted into the accommodating portion 31, the locking claws 33 then engage the locking projections 23e to prevent the sub-connector 20A from coming out of the accommodating portion 31.

As shown in FIGS. 4, 5, and 9, each accommodating portion 31 also includes stopper surfaces 35. The stopper surfaces 35 are located further inward in the downward direction Z2, which is the insertion direction of a sub-connector 20A (see FIG. 9), than the open end of the accommodating portion 31. Two stopper surfaces 35 are provided per accommodating portion 31. The two stopper surfaces 35 extend inward toward each other from both sides along the second axis Y.

As shown in FIG. 9, the stopper surfaces 35 engage the retainer pieces 24 that are in the open state, which prevents further insertion of a sub-connector 20A into the accommodating portion 31. In more detail, when a sub-connector 20A is inserted into an accommodating portion 31, the stopper surfaces 35 of the present embodiment engage the retainer pieces 24, which are half open in the open state (see the retainer piece 24 on the left in FIG. 9), which prevents further insertion of the sub-connector 20A. The stopper surfaces 35 of the present embodiment also engage the projections 24c of the retainer pieces 24, thereby preventing further insertion of the sub-connector 20A into the accommodating portion 31. The stopper surfaces 35 in the present embodiment are inclined to guide the retainer pieces 24 in a direction where the retainer pieces 24 open further when, in a state where the projections 24c contact the stopper surfaces 35, an insertion force is applied to the sub-connector 20A. That is, the two stopper surfaces 35 provided for one accommodating portion 31 in the present embodiment are inclined in the upward direction Z1 toward each other.

Also in the present embodiment, the length (i.e., depth) L1 from the open end of an accommodating portion 31 to the stopper surface 35 is set to be greater than the length L2 of the retainer piece 24 along the third axis Z.

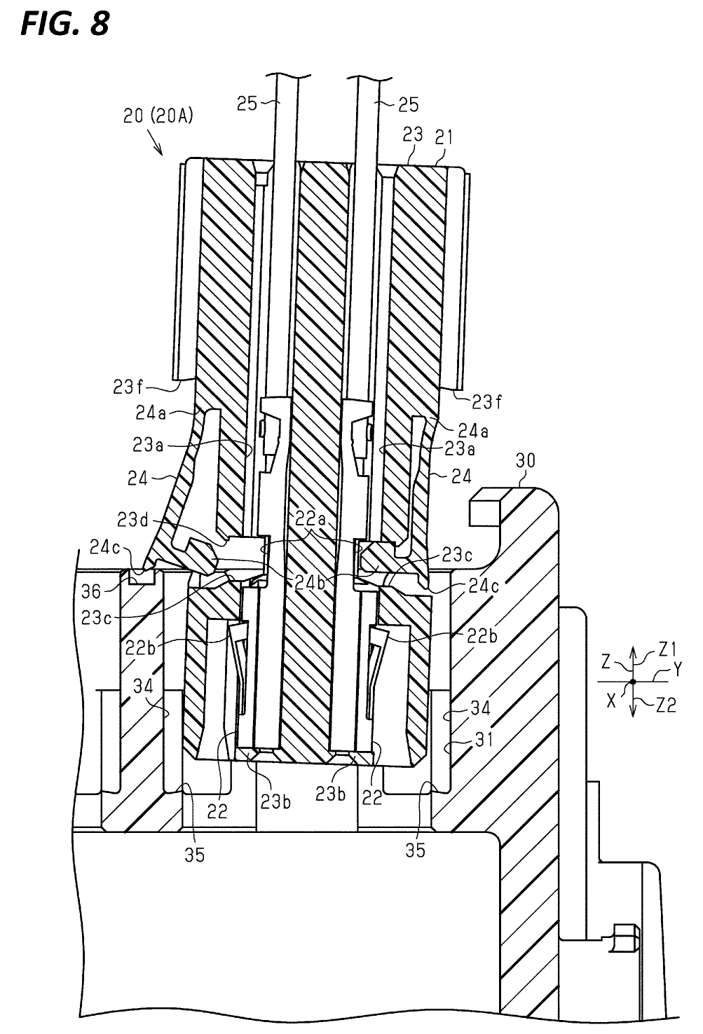

As shown in FIGS. 4, 5, and 8, the frame 30 includes initial engagement recesses 36 on an end surface in the upward direction Z1, which is the direction in which the accommodating portions 31 are open. In the present embodiment, an initial engagement recess 36 is provided on the upward direction Z1 end surface between accommodating portions 31 that are aligned along the second axis Y. As shown in FIG. 8, the initial engagement recess 36 engages the projection 24c of a retainer piece 24 in the open state and prevents the sub-connector 20A from being inserted into the accommodating portion 31. In more detail, the projection 24c of the retainer piece 24 (see the left retainer piece 24 in FIG. 8) that is fully open in the open state will enter and engage the initial engagement recess 36 during an initial insertion of the sub-connector 20A into the accommodating portion 31. With this configuration, further insertion of the sub-connector 20A is prevented. Note that the left retainer piece 24 in FIG. 8 shows a retainer piece 24 that is fully open in spite of the terminal 22 not being inserted to the proper position in a terminal accommodating hole 23a, which occurs when the operator has not placed the retainer piece 24 in the closed state (see FIG. 7).

### (Operation of Connector Assembly 10)

Next, the operation of the connector assembly 10 configured as described above will be described.

In the connector assembly 10 configured as described above, a sub-connector 20A is attached to the frame 30. The sub-connector 20A is inserted into the accommodating portion 31 by being moved relative to the frame 30 in the downward direction Z2 along the third axis Z.

As one example, as shown in FIG. 8, when the retainer piece 24 is in the open state and fully open, the projection 24c of the retainer piece 24 will enter and engage the initial engagement recess 36 during an initial stage of insertion of the sub-connector 20A into the accommodating portion 31. Accordingly, when for example the retainer piece 24 is in the open state and fully open, further insertion of the sub-connector 20A into the accommodating portion 31 is prevented at the initial stage of insertion, which prevents improper attachment.

When as shown in FIG. 9 for example, the retainer pieces 24 are in the open state and half open, the projections 24c of the retainer pieces 24 will engage with the stopper surfaces 35 during an intermediate stage of insertion of the sub-connector 20A into the accommodating portion 31. This means that when the retainer pieces 24 are in the open state and half-open for example, further insertion of the sub-connector 20A into the accommodating portion 31 is prevented at an intermediate stage, which prevents improper attachment.

When the retainer pieces 24 are in the closed state (see FIG. 7), the sub-connector 20A is inserted into the accommodating portion 31 until the stop ribs 23f hit the stopper surfaces 35. As a result of this, the sub-connector 20A is prevented from coming out of the accommodating portion 31 by the locking projections 23e (see FIG. 2) engaging the locking claws 33 (see FIG. 4).

This connector assembly 10 is mated with a mating connector (not illustrated) by moving the connector assembly 10 relative to the mating connector in the downward direction Z2 along the third axis Z. As a result of this, the terminals 22 held in each sub-connector 20 become mated with and electrically connected to the mating terminals (not shown) of the mating connector.

### (Effects of Present Embodiment)

Next, the effects of the present embodiment will be described below.

(1) Each accommodating portion 31 includes the stopper surfaces 35 that engage retainer pieces 24 in the open state to prevent the sub-connector 20A from being inserted into the accommodating portion 31. This prevents the sub-connector 20A from being inserted into the accommodating portion 31 in state where the retainer pieces 24 are not locking the terminals 22. This prevents the sub-connector 20A from being improperly attached to the frame 30. The stopper surfaces 35 are located further inward in the downward direction Z2, which is the insertion direction, than the open end of the accommodating portion 31. Accordingly, even if a strong insertion force is applied to the sub-connector 20A in a state where the retainer pieces 24 engage the stopper surfaces 35 for example, it is possible to prevent buckling of the retainer pieces 24 so as to bulge outward.

In other words, because the stopper surfaces 35 are provided further inward in the downward direction Z2 (the insertion direction) than the open end of the accommodating portion 31, in a state where the retainer pieces 24 engage the stopper surfaces 35, the outer surfaces of the retainer pieces 24 will face the facing surfaces 34 (see FIG. 9), which are the inner wall surfaces of the accommodating portion 31. Accordingly, even if a retainer piece 24 is about to buckle so as to bulge outward, the retainer piece 24 will come into contact with a facing surface 34 of the accommodating portion 31, which prevents the buckling. This makes it possible to prevents breakage of the retainer pieces 24 and ensures stable and proper assembly.

(2) Each retainer piece 24 is formed to be capable of locking a plurality of terminals 22. This means that compared to a configuration in which a single retainer piece can lock a single terminal 22, stress that occurs when a force is applied will be dispersed, which makes the retainer pieces 24 less susceptible to breaking. Accordingly, more stable and proper assembly can be ensured.

(3) Each retainer piece 24 is formed so as to be capable of locking all of the terminals 22 aligned along the first axis X, which is the length axis of the housing 21. Accordingly, compared to a configuration in which a single retainer piece can lock only some of the terminals 22 aligned along the first axis X for example, stress that occurs when a force is applied is more favorably dispersed, which makes the retainer pieces 24 less susceptible to breaking. Accordingly, more stable and proper assembly can be ensured.

(4) Each retainer piece 24 includes a projection 24c at a front end in the downward direction Z2, which is the insertion direction. The stopper surfaces 35 are inclined to guide the retainer pieces 24 in a direction where the retainer pieces 24 open further when, in a state where the projections 24c contact the stopper surfaces 35, an insertion force is applied to the sub-connector 20A. This facilitates proper bracing by the retainer pieces 24. Accordingly, a state where an intermediate portion of a retainer piece 24 starts to bulge outwards, or in other words, starts to buckle is less likely to occur. It is also less likely for a state where a retainer piece 24 is forcibly inserted in the downward direction Z2, which is the insertion direction, beyond a stopper surface 35 to occur.

(5) The length L1 from the open end of an accommodating portion 31 to the stopper surfaces 35 is greater than the length L2 of the retainer pieces 24 along the third axis Z, which is the insertion axis. This means that when the retainer pieces 24 engage the stopper surfaces 35, the facing surfaces 34 (see FIG. 9) of the accommodating portion 31 will face the retainer pieces 24, even at locations near the base end 24a. This prevents outward bulging of the retainer pieces 24, even at locations near their base ends 24a. This can further prevent buckling of the retainer pieces 24.

(6) On the upward direction Z1 end surface, which is the open direction of the accommodating portions 31, the frame 30 includes the initial engagement recesses 36, into which the projections 24c of retainer pieces 24 in the open state will fit and engage to prevent insertion of a sub-connector 20A into an accommodating portion 31. This prevents improper attachment of the sub-connector 20A and the frame 30 at an early stage during attachment. As one example, improper attachment in a state where a retainer piece 24 is in the open state and fully open can be prevented at an early stage. Since the projections 24c of the retainer pieces 24 fit into and engage the initial engagement recesses 36, retainer piece 24 are prevented from becoming excessively open in the outward direction, which facilitates proper bracing by the retainer pieces 24.

### (Modifications)

The embodiment described above can be modified as follows. The embodiment described above and the following modifications can be combined with each other within a range that remains technically consistent.

Although the retainer pieces 24 are formed so that a single retainer piece 24 is capable of locking all of the terminals 22 aligned along the first axis X, which is the length axis of the housing 21 in the embodiment described above, this is not a limitation.

As one example, although not mentioned in the embodiment described above, as shown in FIG. 2, retainer pieces 40, 41 of the sub-connector 20B are provided as two different types along the first axis X. That is, the sub-connector 20B holds two types of terminals (not shown) in the direction along the first axis X, and the retainer pieces 40 and 41 are provided to bend independently for the different types of terminal.

As another example, each retainer piece 24 may also be formed to be capable of locking one terminal 22. In other words, retainer pieces 24 may also be provided to bend independently for each terminal 22.

Although the stopper surfaces 35 are inclined to guide the retainer pieces 24 in a direction where the retainer pieces 24 become further open when an insertion force is applied to a sub-connector 20A in a state where the projections 24c of the retainer pieces 24 contact the stopper surfaces 35 in the above embodiment, this is not a limitation. That is, the stopper surfaces 35 may also be surfaces that are perpendicular to the third axis Z, which is the insertion axis of the sub-connector 20A.

Although the length L1 from the open end of an accommodating portion 31 to the stopper surfaces 35 is greater than the length L2 along the third axis Z of the retainer pieces 24 in the embodiment described above, this is not a limitation. That is, the length L1 from the open end of the accommodating portion 31 to the stopper surfaces 35 may also be equal to or less than the length L2 along the third axis Z of the retainer pieces 24. Note that it is preferable for the length L1 from the open end of an accommodating portion 31 to the stopper surfaces 35 to be greater than half the length L2 along the third axis Z of the retainer pieces 24.

Although in the embodiment described above, the frame 30 includes the initial engagement recesses 36 in the upward direction Z1 end surface, which is the open direction of the accommodating portions 31, this is not a limitation and it is also possible to use a configuration where the frame 30 does not include the initial engagement recesses 36.

Although the frame 30 includes six accommodating portions 31 in the embodiment described above, this is not a limitation. The number of accommodating portions 31 included in the frame 30 may be changed to a different number. It should be obvious that the number of sub-connectors 20A, 20B included in the connector assembly 10 may also be changed.

Although the housing body 23 of the sub-connector 20A has 26 terminal accommodating holes 23a in the embodiment described above, this is not a limitation. The number of terminal accommodating holes 23a included in the housing body 23 may be changed. It should be obvious that the number of terminals 22 held by the housing 21 may also be changed.

Although the connector assembly 10 including a plurality of sub-connectors 20 and the frame 30 is described in detail in the embodiment described above, the present disclosure may also be realized using another connector assembly that includes connectors aside from the sub-connectors 20 and/or a mating component aside from the frame 30.

The embodiment disclosed above is exemplary in all respects and should not be regarded as limitations on the present disclosure. The scope of the present disclosure is indicated by the range of the patent claims, and is intended to include all changes within the meaning and scope of the patent claims and their equivalents.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector assembly comprising:
a connector including a housing and a terminal held in the housing; and
a mating component including an accommodating portion into which the connector is capable of being inserted along an insertion axis,
wherein the housing includes a housing body capable of accommodating the terminal and a retainer piece that is integrally molded with the housing body,
the retainer piece is formed so as to be capable of bending about a base end thereof as a pivot from an open state in which the retainer piece extends diagonally relative to an insertion direction of the connector to a closed state in which the retainer piece extends in the insertion direction,
in the open state, the retainer piece allows the terminal to be inserted into the housing body, and in the closed state, the retainer piece locks the terminal that has been accommodated in the housing body, and
the accommodating portion includes a stopper surface, which is located at a position further inward in the insertion direction than an open end of the accommodating portion and engages with the retainer piece in the open state to prevent the connector from being inserted into the accommodating portion.

2. The connector assembly according to claim 1,
wherein the connector includes a plurality of the terminals, and
the retainer piece is formed so that a single retainer piece is capable of locking the plurality of terminals.

3. The connector assembly according to claim 2,
wherein the housing is formed as a rectangular cuboid, and
the retainer piece is formed so that a single retainer piece is capable of locking all of the plurality of terminals aligned along a length direction of the housing.

4. The connector assembly according to claim 1,
wherein the retainer piece includes a projection at a front end in the insertion direction, and
the stopper surface is inclined to guide the retainer piece in a direction where the retainer piece opens further when an insertion force is applied to the connector in a state where the projection contacts the stopper surface.

5. The connector assembly according to claim 1,
wherein a length from an open end of the accommodating portion to the stopper surface is longer than a length along the insertion axis of the retainer piece.
